(19) United States
(12) Patent Application Publication
(10) Pub. No.: US 2006/0241932 A1
(43) Pub. Date: Oct. 26, 2006

(54) Translation previewer and validator

(76) Inventors: Ron C. Carman, Lexington, KY (US); Paul J. Cote, Paris, KY (US); Mark A. Robb, Lexington, KY (US); Stephanie S. Thorpe, Richmond, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/110,319

(22) Filed: Apr. 20, 2005

(51) Int. Cl. G06F 17/28

(52) U.S. Cl. 704/2

(57) ABSTRACT

A method and system for format checking a translated text in which the method includes displaying the translated text on a graphical user interface, determining whether the translated text is visually acceptable based on the displaying, and validating the translated text. The system includes a graphical user interface, a storage medium having at least one translated text stored therein, and a processor adapted to read the translated text from the storage medium and display the translated text on the graphical user interface as a virtual display.

### BACKGROUND

The present application relates to a system and method for format checking a translation and, more particularly, a system and method for previewing and validating a translation.

Office equipment, such as printers and multi-functional devices, are typically sold internationally. Therefore, the display panels and web pages associated with the office equipment are typically adapted to display text in various languages. However, in order for the text to be properly displayed, the translated text must meet certain format requirements. For example, the translated text must not exceed a predetermined length in pixels or characters.

When a text string is translated from one language to another, various factors contribute to format errors. One factor that contributes to format errors is that different languages use different types of characters. For example, the English language utilizes Latin characters, the Chinese language utilizes Chinese characters and the Ukrainian language utilizes Cyrillic characters. Therefore, a text string in one language may have a first length while the same text string translated into another language may have a different (e.g., longer) length due to the different characters.

Accordingly, there is a need for a system and method for checking a translated text to determine whether the translated text is in a proper format.

### SUMMARY

In one aspect, the translation previewer and validator provides a method for format checking a translated text including displaying the translated text on a graphical user interface, determining whether the translated text is visually acceptable based on the displaying, and validating the translated text.

In a second aspect, the translation previewer and validator provides a method for format checking a translated text including displaying the translated text on a graphical user interface, visually inspecting the displayed text to determine whether the translated text is acceptable, and validating the translated text, wherein the validating includes at least one of (1) determining whether the translated text is valid and well-formed, (2) determining whether the translated text exceeds at least one of a predetermined number of lines, characters and pixels and (3) determining whether the translated text includes unrecognized characters.

In a third aspect, the translation previewer and validator provides a system for format checking a translation. The system includes a graphical user interface, a storage medium having at least one translated text stored therein and a processor, wherein the processor is adapted to read the translated text from the storage medium and display the translated text on the graphical user interface as a virtual display.

Other aspects of the translation previewer and validator will be apparent from the following description, the accompanying drawings and the appended claims.

### BRIEF DESCRIPTION OF THE DRAWINGS

FIG. 1 is a block diagram of a first aspect of the translation previewer and validator; and

FIG. 2 is a flow diagram of a second aspect of the translation previewer and validator.

### DETAILED DESCRIPTION

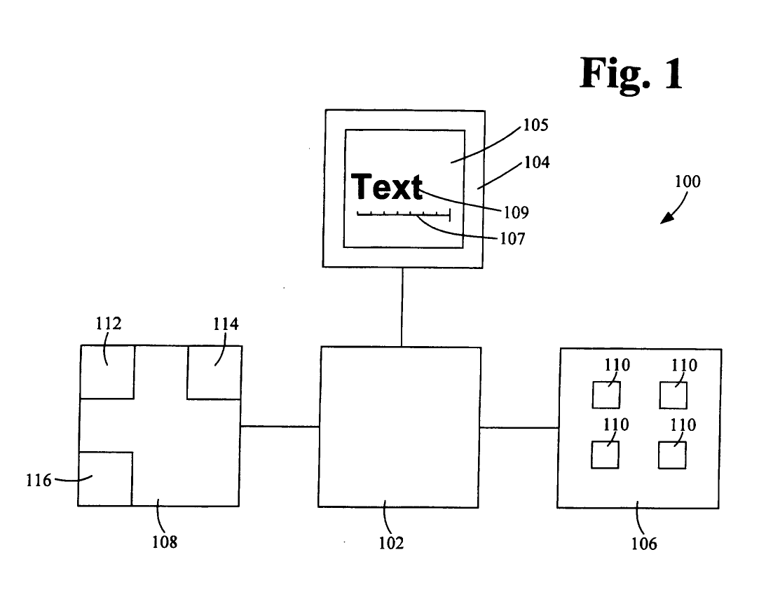

As shown in FIG. 1, one aspect of the translation previewer and validator provides a system, generally designated 100, for format checking a translated text 109. The system 100 includes a processor 102, a graphical user interface 104, a translation storage medium 106 and a validation data storage medium 108.

A text string to be translated may be sent to a translation vendor as an XML document. It should be understood by those skilled in the art that various formats, other than XML, may be used within the scope of the translation previewer and validator. For example, any format capable of storing, sorting and/or presenting electronic data may be used, including, but not limited to, HTML, XHTML or other markup-type languages. The translation vendor may then translate the text string into the appropriate language and store the translated text 109 as a data file 110 (e.g., an XML file) in the translation storage medium 106. The file 110 may then be format checked, as described herein.

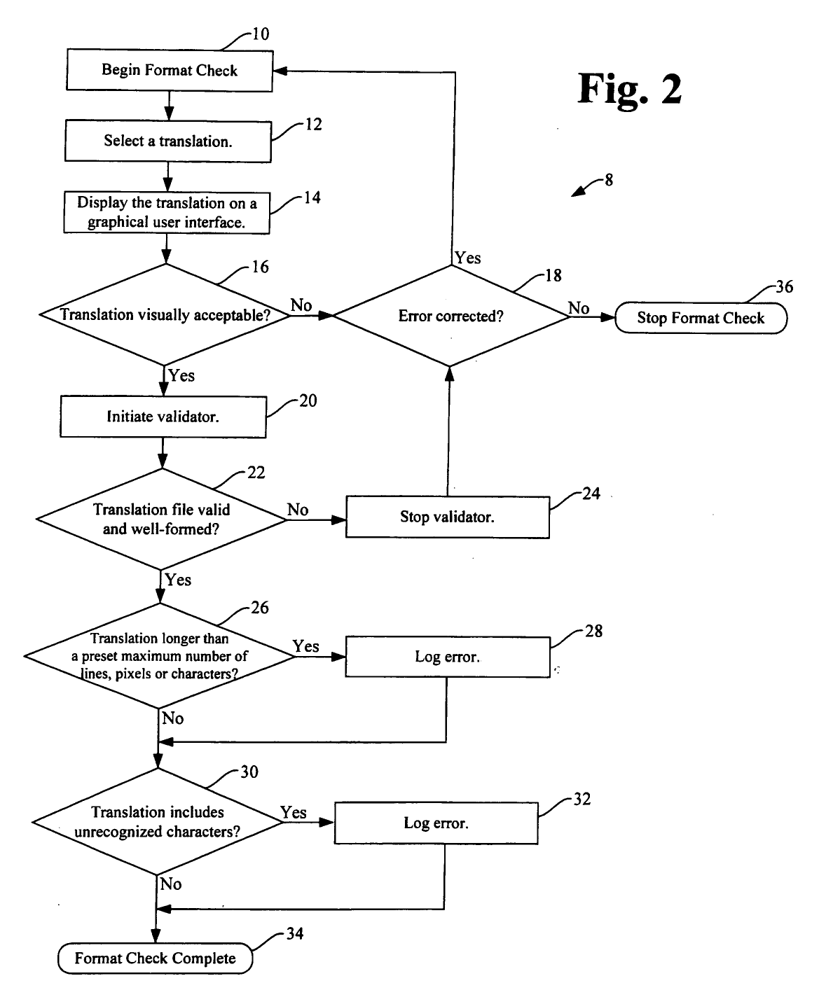

As shown in FIG. 2, the format checking process, generally designated 8, begins at box 10. The format checking process 8 includes a previewer step (see boxes 12 through 18) and a validator step (see boxes 20 through 32). The previewer step begins when the processor 102 (see FIG. 1) selects a file 110 from the translation storage medium 106 for format checking, as shown in box 12. The processor 102 may select a file 110 from the translation storage medium 106 based on a user input or command.

As shown in box 14, the processor 102 displays the translated text 109 of the file 110 on the graphical user interface 104. In one aspect, the file may be an XML file, and an HTML file may be provided for loading the XML file 110 and displaying the XML file 110 (via a JavaScript and an XSL transformation) on the graphical user interface 104 as an HTML document (i.e., in a browser window). In another aspect, the translated text 109 may be displayed in a TrueType font (TrueType is a registered trademark of Apple Computer, Inc.). The TrueType font accurately displays the translated text 109 on the graphical user interface 104, including the various restrictions on each piece of translated text.

In one aspect, the translated text 109 may be displayed in a virtual display 105 that represents the display on which the translated text 109 will ultimately be used. For example, the virtual display 105 may resemble the user interface of a multi-functional device. Thus, as shown in box 16, a user may view the translated text 109 and determine whether the translated text 109 is properly formatted for its intended use (e.g., is sized to properly fit within the virtual display 105). If the translated text is not visually acceptable (i.e., there is a visually recognizable error in the translation), the user is given the opportunity to correct the error, as shown in box 18. If the error is corrected, the previewer step is repeated starting at box 10. However, if the error is not corrected, the format checking process 8 stops, as shown in box 36.

In another aspect, a ruler 107 (see FIG. 1) may be provided in the virtual display 105 to simplify the determination of whether the translated text 109 exceeds a predetermined size or length. Thus, when a user visualizes the translated text 109 in the virtual display 105 (see box 16, FIG. 2) and determines that the translated text 109 extends beyond the limits set by the ruler 107, the user may determine that the translated text 109 is not in the proper format (i.e., there is a visually recognizable error in the translation) and may be given the opportunity to correct the error, as shown in box 18. However, if no visual errors are detected in the translation (i.e., the translation is visually acceptable to the user), the translated text 109 may be validated (i.e., the process 8 may proceed to the validator step), as shown in box 20.

During the validator (or validating) step (see box 20, FIG. 2), the processor 102 may parse the translated text 109 and flag errors based on data stored in the validation storage medium 108. For example, the validation storage medium 108 may include bitmap font data 112 (e.g., character length data), character maps 114 (e.g., data specific to the characters of various languages) and format data 116 (e.g., data necessary to determine whether a file 110 is valid and well-formed).

Thus, as shown in box 22, the processor 102 may determine whether the translation file 110 is valid (i.e., it meets certain predetermined tag requirements) and well-formed (i.e., there are no syntax errors in the file 110), as, for example, defined by the XML 1.0 standard. In another aspect, the processor 102 may determine whether the translation file 110 conforms to the XML Schema defined for the file 110 as stored in the format data 116 of the validation storage medium 108. If an error is detected (e.g., an element of the file is missing a start-tag or an attribute value is not enclosed in quotations), the validator step stops, as shown in box 24, and the user may be given the opportunity to correct the error, as shown in box 18. If the error is not corrected, the format checking process 8 stops, as shown in box 36. However, if the error is corrected, the process 8 may be reinitiated, as shown in box 10.

If the file 110 is valid and well-formed, the processor 102 may check each translated text item 109 to determine whether the text exceeds a predetermined maximum number of lines, pixels or characters, as shown in box 26. The predetermined maximum values for each item may be stored as bitmap font data 112 in the validation storage medium 108. Thus, if the translated text 109 includes more lines than specified as the maximum, exceeds a predetermined number of pixels (i.e., longer than a predetermined length) or, alternatively, a predetermined number of characters, the errors may be logged, as shown in box 28.

The processor 102 may then determine whether unrecognized characters are used in the translated text 109 based on the character maps 114 stored in the validation storage medium 108, as shown in box 30. Thus, only characters present in the character map 114 for the specified translation language may be present in the translated text 109. For example, when an English to Ukrainian translation is requested and the translated text 109 includes Chinese characters, the errors may be logged, as shown in box 32.

The format checking process 8 is complete at box 34. In one aspect, the process 8 may include the additional step of printing a report of the logged errors such that the user has the opportunity to correct the errors. Once the user has corrected the logged errors, the user may reinitiate the format checking process 8 to ensure that the logged errors have been corrected and the translation is in a proper and acceptable format.

Although the translation previewer and validator is shown and described with respect to certain aspects, it is obvious that modifications will occur to those skilled in the art upon reading the specification. The translation previewer and validator includes all such modifications and is limited only by the scope of the claims.

What is claimed is:

1. A method for format checking a translated text comprising:
displaying said translated text on a graphical user interface;
determining whether said translated text is visually acceptable based on said displaying; and
validating said translated text.

2. The method of claim 1 wherein said displaying step includes displaying said translated text in a font that represents an actual appearance of said text.

3. The method of claim 1 wherein said graphical user interface includes a virtual display.

4. The method of claim 1 wherein said graphical user interface includes a ruler.

5. The method of claim 4 wherein said determining includes determining whether said translated text extends beyond said ruler.

6. The method of claim 1 wherein said determining is performed by a user capable of visualizing said graphical user interface.

7. The method of claim 1 wherein said translated text is stored as an XML file.

8. The method of claim 7 wherein said validating includes determining whether said XML file is valid.

9. The method of claim 7 wherein said validating includes determining whether said XML file is well-formed.

10. The method of claim 1 wherein said validating includes determining whether said translated text is longer than a predetermined number of lines.

11. The method of claim 1 wherein said validating includes determining whether said translated text exceeds at least one of a predetermined number of lines, characters and pixels.

12. The method of claim 1 wherein said validating includes determining whether said translated text includes unrecognized characters.

13. A method for format checking translations comprising the steps of:
obtaining a translated text, wherein said translated text has been visually previewed;
storing said translated text as a data file; and
validating said data file.

14. The method of claim 13 wherein said data file is an XML file.

15. The method of claim 13 wherein said validating includes determining whether said data file is valid.

16. The method of claim 13 wherein said validating includes determining whether said data file is well-formed.

17. The method of claim 13 wherein said validating includes determining whether said translated text exceeds at least one of a predetermined number of lines, characters and pixels.

18. The method of claim 13 wherein said validating includes determining whether said translated text includes unrecognized characters.

19. A system for format checking comprising:
a graphical user interface;
a storage medium having at least one translated text stored therein; and
a processor adapted to read said translated text from said storage medium and display said translated text on said graphical user interface as a virtual display.

20. The system of claim 19 wherein said processor is adapted to validate said translated text.
